(19) United States
(12) Patent Application Publication
(10) Pub. No.: US 2008/0220933 A1
(43) Pub. Date: Sep. 11, 2008

(54) VEHICULAR CONTROL APPARATUS AND CONTROL SYSTEM

(75) Inventor: Yasuhiro MAEDA, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/042,431

(22) Filed: Mar. 5, 2008

(30) Foreign Application Priority Data
Mar. 8, 2007 (JP) 2007-058736

(51) Int. Cl. B60W 10/08; B60W 10/10

(52) U.S. Cl. 477/3; 477/20

(57) ABSTRACT

A control apparatus for a vehicle is provided with an electric motor that outputs driving force for running the vehicle; an automatic transmission that establishes a plurality of gears by selectively applying and releasing a plurality of friction apply elements in a predetermined combination for each gear among the plurality of gears, and transmits power from the electric motor to an output shaft of the vehicle; and a torque controlling portion which, when there is a demand for a power-off downshift, controls output torque of the electric motor such that input torque of the automatic transmission becomes constant torque during an inertia phase of that shift, and controls the output torque of the electric motor such that the output torque of the automatic transmission comes to match the torque required after the shift, after rotation synchronization by an apply-side friction apply element is complete.

### INCORPORATION BY REFERENCE

The disclosure of Japanese Patent Application No. 2007-058736 filed on Mar. 8, 2007, including the specification, drawings and abstract is incorporated herein by reference in its entirety.

### BACKGROUND OF THE INVENTION

1. Field of the Invention

The invention relates to a control apparatus and control method of a vehicle such as a hybrid vehicle which has an electric motor that outputs driving force for running the vehicle, and an automatic transmission that establishes a plurality of gears by selectively applying and releasing a plurality of friction apply elements in a predetermined combination for each gear among the plurality of gears. More particularly, the invention relates to a vehicular control apparatus and control method of a vehicle which outputs power from the electric motor to an output shaft (i.e., driving wheels) via the automatic transmission.

2. Description of the Related Art

In recent years, there has been a demand for better fuel efficiency and reduced exhaust gas emissions output from the engines (i.e., internal combustion engines) of vehicles in order to reduce their impact on the environment. Hybrid vehicles, which employ a hybrid system, are being put into practical use as one type of vehicle that meets this demand.

Hybrid vehicles are provided with an engine such as a gasoline engine or a diesel engine, and an electric motor (such as a motor/generator or motor) which generates power (i.e., electricity) from the output of the engine or generates power to assist the engine output by being driven by a battery. The hybrid vehicle is thus able to use either the engine or the motor, or a combination of the two, as the driving source (i.e., prime mover) for running.

In a hybrid vehicle, the operating ranges (more specifically, driving or stopping) of the engine and the electric motor are controlled based on vehicle speed and accelerator operation amount. For example, in the range where engine efficiency is low, such as during take-off and low speed running, the engine is stopped and the driving wheels are driven using only power from the electric motor. Also, during normal running, control is performed such that the engine is driven and the driving wheels are driven using the power from the engine. Further, at high loads such as when accelerating with the throttle fully open, control is performed such that power is supplied to the electric motor from the battery and the power generated by the electric motor is used as auxiliary power that is added to the power generated by the engine.

In a vehicle such as a hybrid vehicle, an automatic transmission that automatically establishes the optimum gear ratio between a driving source such as an engine or electric motor and the driving wheels is known to be used as a transmission that transmits torque and rotation speed generated by the driving source to the driving wheels appropriately according to the running state of the vehicle.

Two such automatic transmissions that are used in vehicles are planetary gear type transmissions that establish a gear (i.e., speed) using a planetary gear set together with clutches and brakes which are friction apply elements, and belt-type continuously variable transmissions (CVT) that adjust the gear ratio continuously (i.e., in a stepless manner).

One example of a hybrid vehicle has a power outputting apparatus that outputs power from an electric motor (motor) to an output shaft of the vehicle via an automatic transmission. Some such power outputting apparatuses employ technology that suppresses shift shock that occurs when changing gears in the automatic transmission, like the technology described in Japanese Patent Application Publication No. 2006-056343 (JP-A-2006-056343).

With the technology described in JP-A-2006-056343, when changing gears in an automatic, transmission that changes the output speed of a motor MG2 and outputs that changed output speed to the output shaft, while transmitting torque from the motor MG2, shift shock that occurs due to a drop in torque and the like when changing gears is reduced by keeping the motor torque of the motor MG2 at the motor torque before a gear change until the rotation speed of the motor MG2 reaches a rotation speed that is near the rotation speed after the gear change.

In a vehicle that outputs power from an electric motor to an output shaft via a planetary gear type automatic transmission, constant power from the electric motor and the like (i.e., input rotation speed×input torque=constant) is normally input to the automatic transmission. When the input of the automatic transmission is constant power in this way, the absolute value of the input torque (negative torque) decreases according to the input rotation speed in the inertia phase during a power-off downshift (i.e., during a downshift when the engine is being driven by the wheels). As a result, a shock occurs upon the completion of synchronization. This will be described below.

First, when performing a shift from second gear (2nd) into first gear (1st), for example, according to clutch-to-clutch shift control in which a release-side friction apply element is released while an apply-side friction apply element is simultaneously applied, as shown in FIG. 10, the clutch torque Tcdrn of the release-side friction apply element decreases and the clutch torque Tcapl of the apply-side friction apply element increases from time t1 at which there was a shift demand. Then after the inertia phase starts at time t2, the clutch torque Tcapl of the apply-side friction apply element is controlled so that it is substantially constant by keeping the specified hydraulic pressure of the apply-side friction apply element constant. At this time, if the input into the automatic transmission is constant power ([input rotation speed Nm]×[input torque Tm]=constant), then the absolute value |Tm| of the input torque (i.e., negative torque) decreases significantly (|Tm0|→|Tm5|) as the input rotation speed Nm changes from Nm0 to Nm3 during the inertia phase, and as a result, the torque of the inertia portion increases (shown by the hatched portion in FIG. 10).

That is, the relationship between the input torque Tm, the clutch torque Tc, and the torque of the inertia portion [I(dω/dt)] is such that Tm+Tc=I (dω/dt)→Tc=−Tm+I(dω/dt). Thus, if the clutch torque Tcapl of the apply-side friction apply element is substantially constant (i.e., Tc=constant), the torque of the inertia portion [I(ω/dt)] will increase according to the decrease in the absolute value |Tm| of the input torque. The transmission of the torque of the inertia portion [I(dω/dt)] that is increased in this way disappears at time t3 when rotation synchronization by the apply-side friction apply element is complete so the output torque To changes significantly (To3→To5) upon the completion of synchronization such that an abrupt synchronization shock is produced.

Incidentally, in order to prevent the torque of the inertia portion [I(dω/dt)] from increasing during the inertia phase, the clutch torque Tcapl of the apply-side friction apply element may be quickly and accurately reduced according to the decrease (|Tm0|→|Tm5|) in the absolute value |Tm| of the input torque. However, in reality it is difficult to execute control that accurately reduces the clutch torque Tcapl once it has increased.

Here, the technology described in JP-A-2006-056343 keeps the motor torque of the motor MG2 during a downshift at the motor torque before the gear change until the rotation speed of the motor MG2 reaches a rotation speed that is near the rotation speed after the gear change. However, because the increase in the motor torque is complete before the shift is complete (i.e., before the rotation is synchronized by the apply-side apply element), shift shock may occur. Also, with the technology described in JP-A-2006-056343, it is not possible to resolve the problem caused by the increase in the torque of the inertia portion [I(dω/dt)] during the inertia phase.

### SUMMARY OF THE INVENTION

This invention provides a vehicular control apparatus and control method which reduces shock during synchronization by suppressing an increase in torque of an inertia portion during an inertia phase when a power-off downshift is performed in a vehicle that outputs power from an electric motor to an output shaft (i.e., driving wheels) via an automatic transmission.

A first aspect of the invention relates to a vehicular control apparatus. This vehicular control apparatus includes an electric motor that outputs driving force for running the vehicle; an automatic transmission that establishes a plurality of gears by selectively applying and releasing a plurality of friction apply elements in a predetermined combination for each gear among the plurality of gears, and transmits power from the electric motor to an output shaft of the vehicle; and a torque controlling portion which, when there is a demand for a power-off downshift, controls output torque of the electric motor such that input torque of the automatic transmission becomes constant torque during an inertia phase of that shift, and controls the output torque of the electric motor such that the output torque of the automatic transmission comes to match the torque required after the shift, after rotation synchronization by an apply-side friction apply element is complete.

According to this aspect, instead of normally making the input of the automatic transmission constant power during the inertia phase when a power-off downshift is being performed, the output torque of the electric motor is controlled so that the input torque of the automatic transmission is constant (i.e., constant torque). As a result, shock that occurs upon the completion of synchronization can be suppressed.

Also, a second aspect of the invention relates to a control method for a vehicle provided with an electric motor that outputs driving force for running the vehicle, and an automatic transmission that establishes a plurality of gears by selectively applying and releasing a plurality of friction apply elements in a predetermined combination for each gear among the plurality of gears, and transmits power from the electric motor to an output shaft of the vehicle. This control method includes i) controlling, when there is a demand for a power-off downshift, output torque of the electric motor such that input torque of the automatic transmission becomes constant torque during an inertia phase of that shift, and ii) controlling, after rotation synchronization by an apply-side friction apply element is complete, the output torque of the electric motor such that the output torque of the automatic transmission comes to match the torque required after the shift.

According to the invention, when a power-off downshift is performed, the output torque of the electric motor is controlled so that the input torque of the automatic transmission is constant torque during the inertia phase of that shift. As a result, the torque of the inertia portion during the inertia phase can be kept substantially constant. Accordingly, the change in the output torque during synchronization by the apply-side friction apply element can be kept to a minimum without performing complicated hydraulic pressure control, which enables shock that occurs during synchronization to be significantly reduced. Moreover, the negative torque during the inertia phase can be increased which enables the amount of power (i.e., electricity) that is regenerated to be increased, i.e., enables fuel efficiency to be improved.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein.

FIG. 1 is a block diagram schematically showing an example of a hybrid vehicle to which a control apparatus according to an example embodiment of the invention can be applied;

FIG. 2 is a block diagram schematically showing an automatic transmission employed in the hybrid vehicle shown in FIG. 1;

FIG. 3 is a brake application chart of the automatic transmission shown in FIG. 1;

FIG. 4 is a block diagram showing a control system that includes an ECU shown in FIG. 1;

FIG. 5 is a view of an example of a map used to calculate required torque;

FIG. 6 is a view of an example of a shift map used in shift control;

FIG. 7 is a flowchart illustrating an example of torque control during a power-off downshift;

FIG. 8 is a time chart showing an example of torque control during a power-off downshift;

FIG. 9 is a block diagram schematically showing another example of a hybrid vehicle to which the control apparatus according to the example embodiment of the invention can be applied; and

FIG. 10 is a time chart showing an example of power control (i.e., constant power control) during a power-off downshift according to related art.

### DETAILED DESCRIPTION OF THE EMBODIMENTS

In the following description and the accompanying drawings, the present invention will be described in more detail in terms of example embodiments.

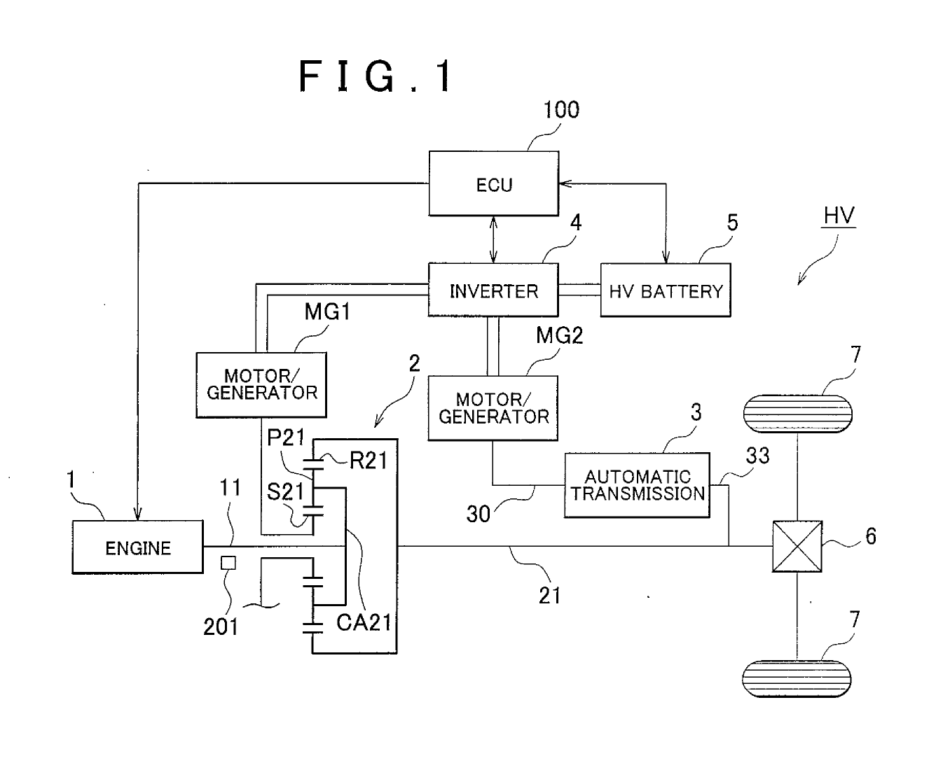

FIG. 1 is a block diagram schematically showing an example of a hybrid vehicle to which a control apparatus according to an example embodiment of the invention can be applied.

The hybrid vehicle HV shown in FIG. 1 is provided with an engine 1, a motor/generator MG1, a motor/generator MG2, a power transmitting mechanism 2, an automatic transmission 3, an inverter 4, a HV battery 5, a differential gear 6, driving wheels 7, and an ECU (Electronic Control Unit) 100 and the like.

Each of these will now be described.

The engine 1 is a known powering apparatus such as a gasoline engine or a diesel engine that outputs power by burning fuel, and is structured such that the operating state, e.g., the throttle opening amount (i.e., intake air amount), the fuel injection quantity, and the ignition timing and the like, can be controlled. The rotation speed of a crankshaft 11 which serves as an output shaft of the engine 1 (i.e., the engine speed) is detected by an engine speed sensor 201. The engine 1 is controlled by the ECU 100.

The motor/generators MG1 and MG2 are alternating current synchronous motors that can function both as electric motors and as generators. These motor/generators MG1 and MG2 are connected to the HV battery 5 via an inverter 4 which is controlled by the ECU 100. The motor/generators MG1 and MG2 are controlled to either regenerate power (i.e., electricity) or provide power (i.e., assist power) by controlling the inverter 4. The regenerative power when the motor/generator MG1 and MG2 are controlled to regenerate power is used to charge the HV battery 5 via the inverter 4. Also, the power for driving the motor/generators MG1 and MG2 is supplied from the HV battery 5 via the inverter 4.

The power transmitting mechanism 2 includes a sun gear S21 which is a gear with external teeth, a ring gear R21 which is a gear with internal teeth that is arranged on the same axis as the sun gear S21, a plurality of D pinion gears P21 that are in mesh with both the sun gear S21 and the ring gear R21, and a carrier CA21 that rotatably and revolvably retains the plurality of pinion gears P21. The sun gear S21, the ring gear R21 and the carrier CA21 are all rotating elements that together make up a planetary gear set that performs differential operation.

The crankshaft 11, which serves as the output shaft of the engine 1, is connected to the carrier CA21 of the power transmitting mechanism 2. Also, a rotating shaft of the motor/generator MG1 is connected to the sun gear S21 of the power transmitting mechanism 2, and a ring gear shaft 21 is connected to the ring gear R21 of the power transmitting mechanism 2. The ring gear shaft 21 is connected to the driving wheels 7 via the differential gear 6. Also, a rotating shaft of the motor/generator MG2 is connected to the ring gear shaft 21 via the automatic transmission 3.

In the power transmitting mechanism 2 having this kind of structure, when the motor/generator MG1 is functioning as a generator, power from the engine 1 which is input from the carrier CA21 is distributed between the sun gear S21 side and the ring gear R21 side according to the gear ratio of the two. On the other hand, when the motor/generator MG1 is functioning as an electric motor, power from the engine 1 which is input from the carrier CA21 is combined with power from the motor/generator MG1 which is input from the sun gear S21, and that combined power is output to the ring gear R21.

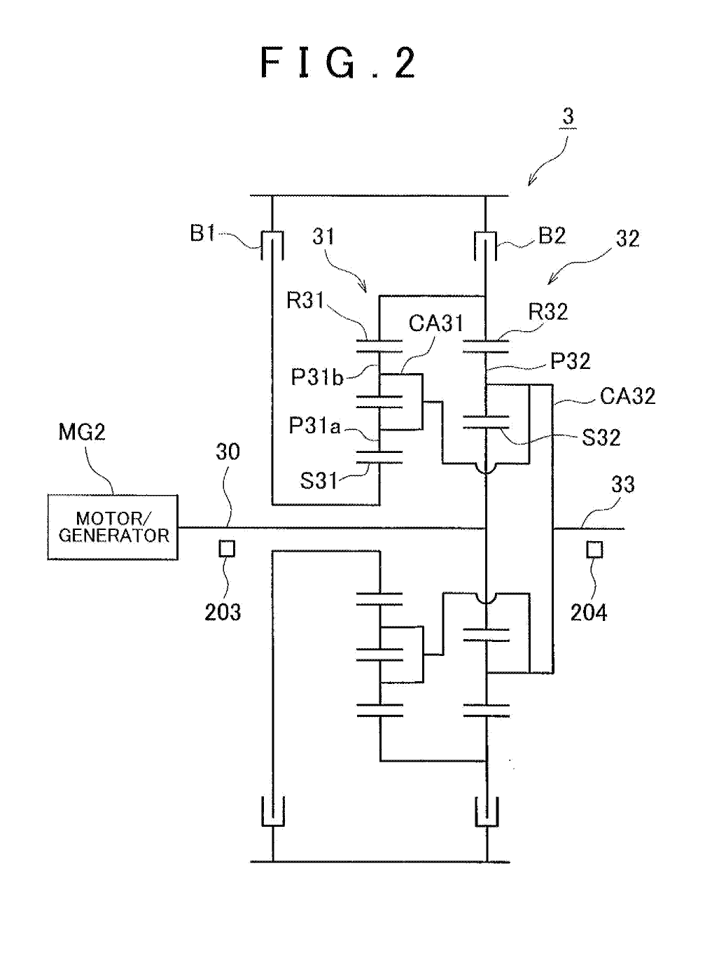

As shown in FIG. 2, the automatic transmission 3 is a planetary gear type transmission that includes a double pinion type first planetary gear set 31, a single pinion type second planetary gear set 32, and two brakes B1 and B2 and the like. An input shaft 30 is connected to a rotating shaft of the motor/generator MG2. Also, an output shaft 33 of the automatic transmission 3 is connected to the ring gear shaft (i.e., the output shaft) 21 shown in FIG. 1.

The first planetary gear set 31 has a sun gear S31 which is a gear with external teeth, a ring gear R31 which is a gear with internal teeth that is arranged on the same axis as the sun gear S31, a plurality of first pinion gears P31a which are in mesh with the sun gear S31, a plurality of second pinion gears P31b which are in mesh these first pinion gears P31a as well as the ring gear R31, and a carrier CA31 that rotatably and revolvably retains the plurality of first pinion gears P31a and the plurality of second pinion gears P31b. The carrier CA31 of the first planetary gear set 31 is integrally connected to a carrier CA32 of the second planetary gear set 32. The sun gear S31 of the first planetary gear set 31 can be selectively connected to a housing, which is a non-rotating member, via the brake B1 such that when the brake B1 is applied) the sun gear S31 is prevented from rotating.

The second planetary gear set 32 has a sun gear S32 which is a gear with external teeth, a ring gear R32 which is a gear with internal teeth that is arranged on the same axis as the sun gear S32, a plurality of pinion gears P32 which are in mesh with both the sun gear S32 and the ring gear R32, and the carrier CA32 that rotatably and revolvably retains the plurality of pinion gears P32. The sun gear S32 of the second planetary gear set 32 is connected to the input shaft 30, and the carrier CA32 is connected to the output shaft 33. Furthermore) the ring gear 132 of the second planetary gear set 32 can be selectively connected to the housing via the brake B2 such that when the brake B2 is applied, the ring gear R32 is prevented from rotating.

The rotation speed of the input shaft 30 of the automatic transmission 3 (i.e., the input rotation speed Nm) is detected by an input shaft rotation speed sensor 203. Also, the rotation speed of the output shaft 33 of the automatic transmission 3 is detected by an output shaft rotation speed sensor 204. The current gear of the automatic transmission 3 can be determined based on the ratio of the rotation speeds obtained from output signals from the input shaft rotation speed sensor 203 and the output shaft rotation speed sensor 204 (i.e., output rotation speed/input rotation speed).

The automatic transmission 3 can switch between a variety of ranges, such as a P-range (i.e., parking range), an N-range (i.e., neutral range), and a D-range (i.e., forward running range or drive range) and the like, by a driver operating a range changing device such as a shift lever.

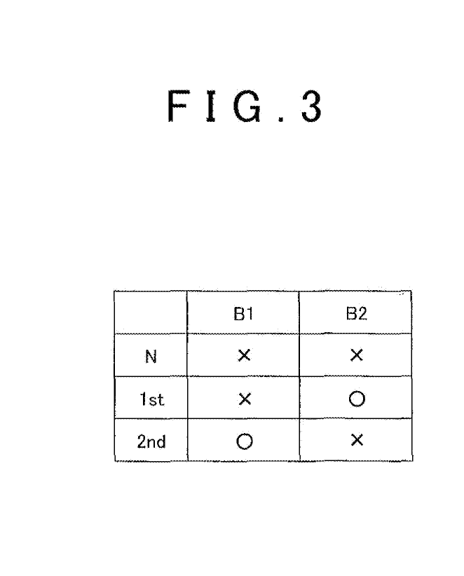

The automatic transmission 3 establishes various gears (i.e., speeds) by selectively applying and releasing the brakes B1 and B2, which are friction apply elements, in a predetermined combination for each gear. The brake application chart in FIG. 3 shows the different apply and release combinations of the brakes B1 and a B2 of the automatic transmission 3. In the brake application chart in FIG. 3, a circle indicates that the brake B1 or B2 is applied, and an X indicates that the brake B1 or 12 is released.

As shown in FIG. 3, releasing both of the brakes B1 and 82 releases both the input shaft 30 (i.e., the rotating shaft of the motor/generator MG2) and the output shaft 33 (i.e., the ring gear shaft 21) (i.e., places the automatic transmission 3 in a neutral state).

Also, first gear (1st) is established by applying the brake B2 and releasing the brake B1. When the brake B2 is applied, the ring gear R32 of the second planetary gear set 32 is held against rotation. When the ring gear R32 is held against rotation in this way and the sun gear S32 is rotated by the motor/generator MG2, the carrier CA32, i.e., the output shaft 33, rotates at low speed.

Second gear (2nd) is established by applying the brake 131 and releasing the brake B2. When the brake B1 is applied, the sun gear S31 of the first planetary gear set 31 is held against rotation. When the sun gear S31 is held against rotation in this way and the sun gear S32 (ring gear 31) is rotated by the motor/generator MG2, the carrier CA32 (carrier CA31), i.e., the output shaft 33, rotates at high speed.

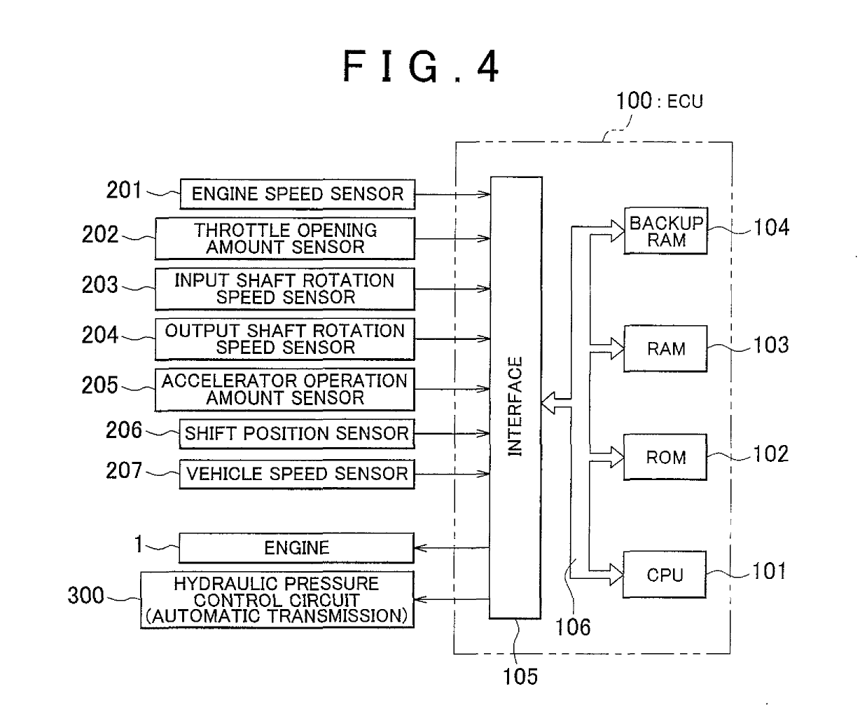

An upshift from first gear (1st) into second gear (2nd) in this automatic transmission 3 is achieved according to clutch-to-clutch shift control that releases the brake B2 while simultaneously applying the brake B1. Also, the downshift from second gear (2nd) into first gear (1st) is achieved according to clutch-to-clutch shift control that releases the brake B1 while simultaneously applying the brake B2. The hydraulic pressure during apply and release of these brakes B1 and B2 is controlled by a hydraulic pressure control circuit 300 (see FIG. 4).

The hydraulic pressure control circuit 300 includes a linear solenoid valve and an ON-OFF solenoid valve, not shown, and the like. The brakes B1 and B2 of the automatic transmission 3 can be controlled to apply and release by switching the hydraulic circuit which is done by energizing and de-energizing these solenoid valves. The linear solenoid valve and the ON-OFF solenoid valve of the hydraulic pressure control circuit 300 are energized/de-energized in response to a solenoid control signal (i.e., a specified hydraulic pressure signal) from the ECU 100.

As shown in FIG. 4, the ECU 100 includes a CPU 101, ROM 102, RAM 103, and backup RAM 104 and the like.

In the ROM 102 are stored various programs, including a program for executing shift control that establishes the gear in the automatic transmission 3 according to the running state of the hybrid vehicle HV, as well as control related to the basic operation of the hybrid vehicle HV. The specific details of this shift control will be described later. In addition to these programs, maps which will be described later and the like are also stored in the ROM 102.

The CPU 101 executes computations based on the various control programs and maps stored in the ROM 102. Also, the RAM 103 is memory that temporarily stores the computation results of the CPU 101 and data input from the sensors and the like. The backup RAM 104 is nonvolatile memory that stores data and the like to be saved while the engine 1 is stopped.

The CPU 101, the ROM 102, the RAM 103, and the backup RAM 104 are all connected together as well as to an interface 105 via a bus 106.

Various sensors are also connected to the interface 105 of the ECU 100. Among these sensors are an engine speed sensor 201, a throttle opening amount sensor 202 that detects the opening amount of a throttle valve of the engine 1, the input shaft rotation speed sensor 203, the output shaft rotation speed sensor 204, an accelerator operation amount sensor 205 that detects the operation amount of an accelerator pedal, a shift position sensor 206 that detects the position of a shift lever, and a vehicle speed sensor 207 that detects the speed of the hybrid vehicle HV. The signals output from these sensors are all input to the ECU 100.

The ECU too executes various controls of the engine 1, including throttle opening amount (i.e., intake air amount) control of the engine 1, fuel injection quantity control, and ignition timing control, based on the signals output from the various sensors described above.

The ECU 100 outputs a solenoid control signal (i.e., a specified hydraulic pressure signal) to the hydraulic pressure control circuit 300 of the automatic transmission 3. The linear solenoid valve and the ON-OFF solenoid valve and the like of the hydraulic pressure control circuit 300 are then controlled based on this solenoid control signal such that the brakes B1 and B2 are applied or released in a predetermined combination to establish a predetermined gear (i.e., first or second gear).

Furthermore, the ECU 100 also executes the following three types of control, i.e., shift control, running control, and torque control during a power-off downshift.

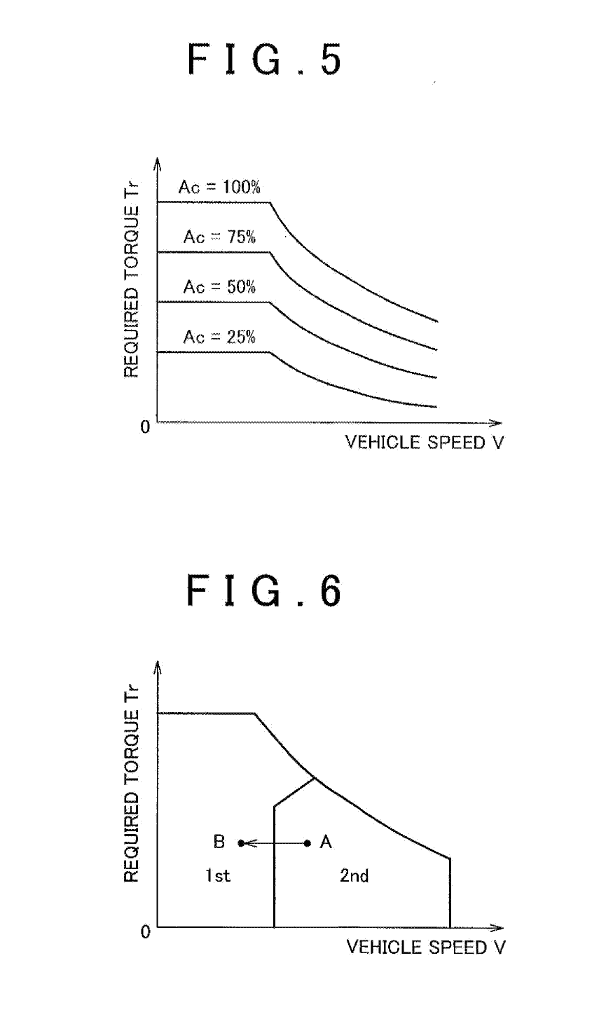

First, the ECU 100 calculates the accelerator operation amount Ac based on the output signal from the accelerator operation amount sensor 205, as well as calculates the vehicle speed V based on the output signal from the vehicle speed sensor 207. The ECU 100 then obtains the required torque Tr referencing the map shown in FIG. 5, based on the calculated accelerator operation amount Ac and vehicle speed V.

Next, the ECU 100 calculates a target gear referencing the shift map shown in FIG. 6, based on the vehicle speed V and the required torque Tr. The ECU 100 also determines the current gear of the automatic transmission 3 based on the ratio of the rotation speeds obtained from the output signals from the input shaft rotation speed sensor 203 and the output shaft rotation speed sensor 204 (i.e., output rotation speed/input rotation speed). Then the ECU 100 compares the target gear with the current gear to determine whether a shift operation is necessary.

If a shift is not necessary (i.e., if the target gear and the current gear are the same, in which case the appropriate gear is already established), the ECU 100 outputs a solenoid control signal (i.e., a specified hydraulic pressure signal) to maintain the current gear to the hydraulic pressure control circuit 300 of the automatic transmission 3.

If, on the other hand, the target gear is different than the current gear, the ECU 100 performs shift control. For example if the hybrid vehicle HV is running with the automatic transmission 3 in second gear and then the running state (such as the vehicle speed) of the hybrid vehicle HV changes (e.g., when there is a change from point A to point B in FIG. 6, for example), the target gear calculated from the shift map becomes first gear. Accordingly, the ECU 100 outputs a solenoid control command (i.e., a specified hydraulic pressure signal) to establish first gear to the hydraulic pressure control circuit 300 of the automatic transmission 3. As a result, a shift from second speed to first speed (i.e., a 2nd→1st downshift) is performed by releasing the brake B1, which is a friction apply element, while simultaneously applying the brake B2, which is also a friction apply element.

Incidentally, the map for calculating the required torque shown in FIG. 5 maps out values of required torque Tr that were empirically-obtained through testing or calculations or the like, and uses the vehicle speed V and the accelerator operation amount Ac as parameters. This map is stored in the ROM 102 of the ECU 100.

Also, the shift map shown in FIG. 6 is a map in which two ranges (i.e., 1st range and 2nd range) for obtaining the appropriate gear are set according to the vehicle speed V and the required torque Tr, which are used as the parameters. This map is also stored in the ROM 102 of the ECU 100. The two ranges in the shift map are divided by a shift line (i.e., a gear shift line).

According to the same process as described above, the ECU 100 calculates the required torque Tr to be output to the ring gear shaft (i.e., the output shaft) 21 referencing the map shown in FIG. 5, based on the accelerator operation amount Ac and the vehicle speed V. Then the ECU 100 runs the hybrid vehicle HV in a predetermined running mode by driving the engine 1 and the motor/generators MG1 and MG2 (i.e., controlling the inverter 4) so that the required power corresponding to that required torque Tr is output to the ring gear shaft 21.

For example, in the range where engine efficiency is low such as during take-off and low speed running, the ECU 100 stops the engine 1 and outputs power commensurate with the required power from the motor/generator MG2 to the ring gear shaft 21 via the automatic transmission 3. During normal running, the ECU 100 drives the engine 1 so that power commensurate with the required power is output from the engine 1, while controlling the speed of the engine 1 using the motor/generator MG1 to achieve optimum fuel efficiency.

Also, when providing torque assist by driving the motor/generator MG2, the ECU 100 executes efficient torque assist by shifting the automatic transmission 3 into first gear (1st) to increase the torque that is added to the ring gear shaft (i.e., the output shaft) 21 when the vehicle speed V is low, and shifting the automatic transmission 3 into second gear (2nd) to relatively reduce the rotation speed of the motor/generator MG2, which in turn reduces loss, when the vehicle speed V is high. Moreover, running control is also executed in which the hybrid vehicle HV is run using only torque that is directly transmitted from the engine 1 to the ring gear shaft 21 via the power transmitting mechanism 2 (i.e., using only directly transmitted torque), while stopping the motor/generator MG2 and having the motor/generator MG1 take the reaction force of the engine torque.

Here, the ECU 100 according to this example embodiment normally controls the motor/generator MG2 according to constant-power control in which a constant-power command is sent to the motor/generator MG2 to control the input torque Tm of the automatic transmission 3 so that constant power is obtained (i.e., input rotation speed×input torque=constant). However, during a power-off downshift, which will be described later, the motor/generator MG2 is controlled according to constant-torque control in which a constant-torque command is sent to the motor/generator MG2 so that the input torque Tm of the automatic transmission 3 remains constant.

First, in the hybrid vehicle HV shown in FIG. 1, i.e., in a hybrid vehicle HV having a structure such that power from the motor/generator MG2 is output to the ring gear shaft (i.e., the output shaft) 21 via the automatic transmission 3, constant power is normally input to the automatic transmission 3. When the input of the automatic transmission 3 is constant power in this way, the absolute value of the input torque (i.e., negative torque) decreases according to the input rotation speed during the inertia phase of a power-off downshift, so a shock is generated upon the completion of synchronization, as described above.

Therefore, in this example embodiment, the input of the automatic transmission 3 is not made to be constant power. Instead, the output torque of the motor/generator MG2 is controlled so that the input torque of the automatic transmission 3 is constant (i.e., constant torque). As a result, shock upon the completion of synchronization is suppressed.

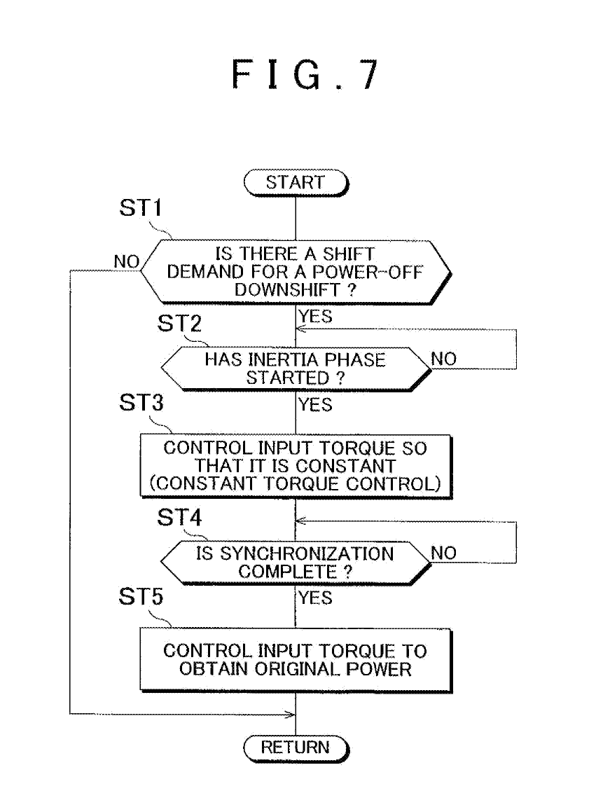

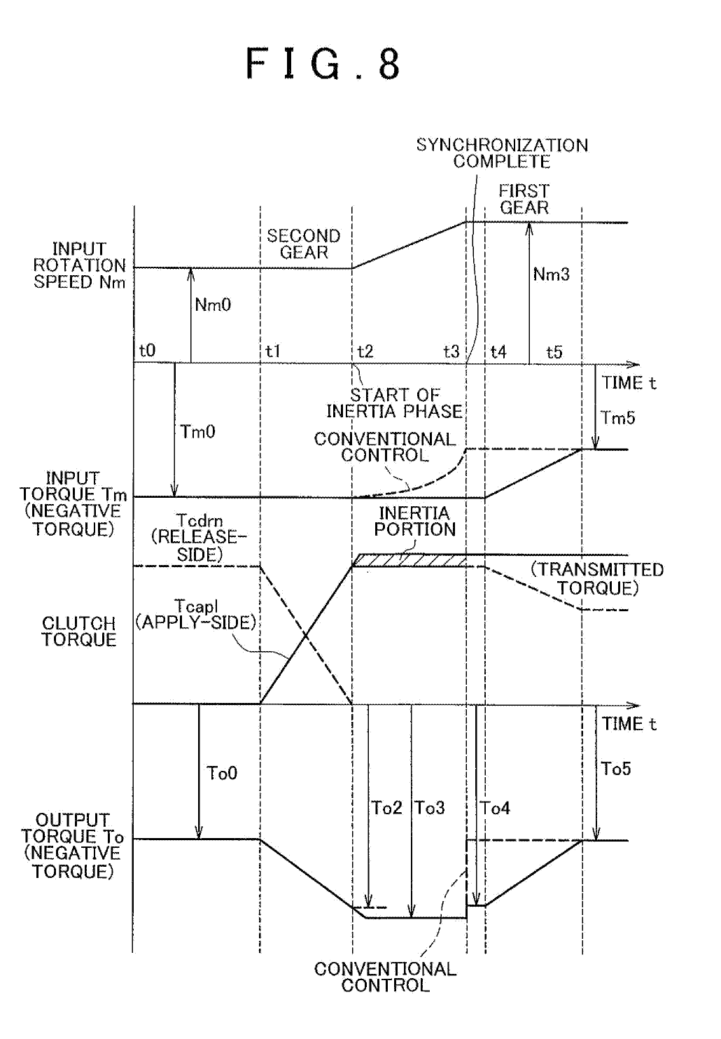

A specific example of this torque control will now be described with reference to the flowchart in FIG. 7 and the timing chart in FIG. 8. The routine to control torque during a power-off downshift which is shown in FIG. 7 is executed by the ECU 100.

First, in step ST1, the ECU too determines whether there is a shift demand for a power-off downshift (i.e., a downshift during which the engine is being driven by the wheels) (2nd→1st) based on various shift demand information that is based on the current running state of the hybrid vehicle HV and the shift map in FIG. 6. If the determination is NO (i.e., if there is no shift demand for a power-off downshift), this cycle of the routine ends. If, on the other hand, the determination is YES (i.e., if there is a shift demand for a power-off downshift), the process proceeds on to step ST2.

Incidentally, the determination in step ST1 of whether the hybrid vehicle HV is in the power-off state (i.e., a state in which the engine is being driven by the wheels) is made by referencing a determination map. The determination map for determining whether the hybrid vehicle HV is in the power-off state is a map that has running states (such as vehicle speed and throttle opening amount) of the hybrid vehicle HV as parameters, and has a power-on (i.e., a state in which the engine is driving the wheels) range and a power-off (i.e., a state in which the engine is being driven by the wheels) range which are empirically obtained through testing or calculations or the like, and a determining line for determining whether the hybrid vehicle HV is in the power-on state or the power-off state that is set based on those ranges. This determination map is stored in the ROM 102 of the ECU 100.

Next, as shown in FIG. 8, from time t1 when there is a power-off downshift demand, the clutch torque Tcdrn of the release-side friction apply element is reduced by releasing the hydraulic pressure in the brake B1 which is the release-side friction apply element, while the clutch torque Tcapl of the apply-side friction apply element is increased by supplying hydraulic pressure to the brake B2 which is the apply-side friction apply element. As a result of this kind of hydraulic pressure control, the inertia phase starts (time t2). After it has been determined that the inertia phase has started (i.e., when the determination in step ST2 is YES), the clutch torque Tcapl of the brake B2, which is the apply-side friction apply element, is controlled so that it is substantially constant by keeping the specified hydraulic pressure of the apply-side friction apply element, i.e., the brake B2, constant.

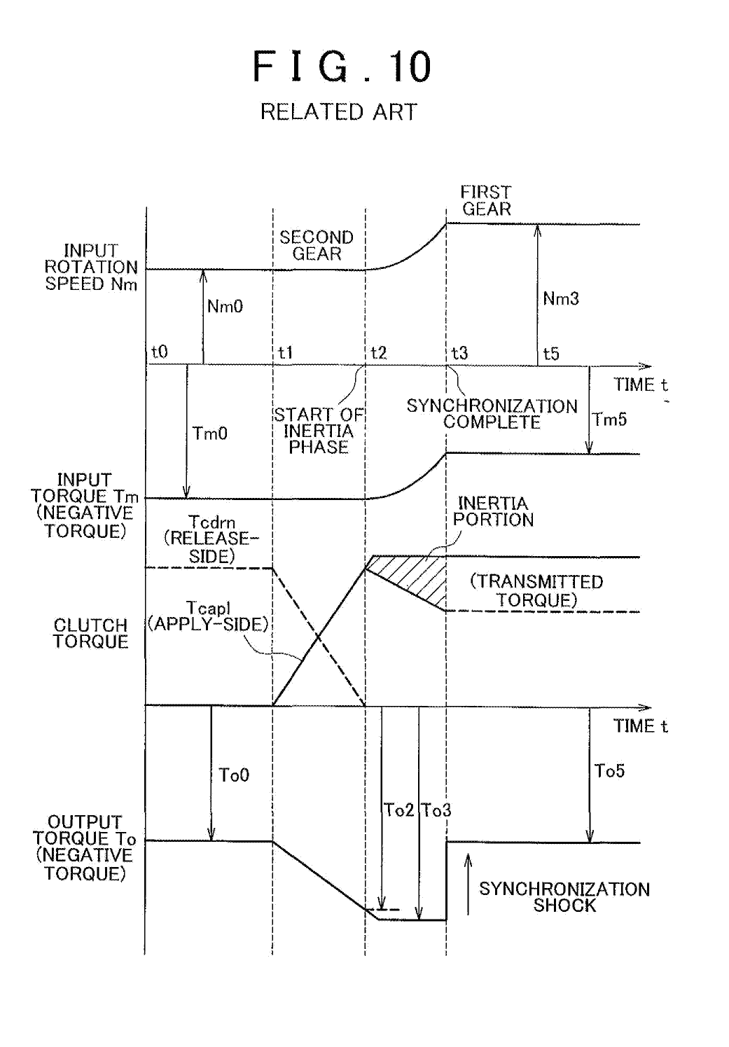

If at this time (i.e., during the inertia phase) the input into the automatic transmission 3 is constant power (i.e., [input rotation speed Nm]×[input torque Tm]=constant), as it is with the control in the related art shown in FIG. 10, the absolute value |Tm| of the input torque (i.e., negative torque) will decrease from |Tm0| to |Tm5| and the torque of the inertia portion will increase as the input rotation speed Nm suddenly changes (from Nm0 to Nm3) during the inertia phase. Upon completion of rotation synchronization by the brake B2, which is the apply-side friction element, the output torque changes significantly (from To3 to To5), resulting in abrupt synchronization shock.

In contrast, with this example embodiment the output torque of the electric motor is controlled (step ST3) such that the input torque of the automatic transmission 3 is constant torque from the start of the inertia phase of a shift until rotation synchronization by the brake B2 (i.e., the apply-side friction apply element) is complete (i.e., during the inertia phase). This kind of constant-torque control (in which the input torque Tm is constant) enables the torque of the inertia portion [I(dω/dt)] to be kept substantially constant (the hatched portion in FIG. 8) even if the clutch torque Tcapl of the apply-side friction apply element is substantially constant, as shown in FIG. 8. That is, the relationship between the input torque Tm, the clutch torque Tc, and the torque of the inertia portion [I(dω/dt)] is such that Tc=−Tm+T(dω/dt), as described above. Therefore, even if the clutch torque Tcapl of the apply-side friction apply element is substantially constant (i.e., even if Tc is constant), the torque of the inertia portion [I(dω/dt) can be kept substantially constant, regardless of the increase (from Nm0 to Nm3) in the input rotation speed Nm during the inertia phase, by controlling the input torque (i.e., the negative torque) Tm so that it is constant.

Accordingly, the change [from To3 to To4] in the output torque To during synchronization (time t3) by the apply-side friction apply element (i.e., the brake B2) can be kept to a minimum, thereby enabling the shock that occurs at synchronization (time t3) to be drastically reduced. Moreover, the negative torque (i.e., the input torque Tm) during the inertia phase can be increased so the amount of power (i.e., electricity) that is regenerated can be increased, i.e., fuel efficiency can be improved.

After it has been determined that rotation synchronization by the brake B2 which is the apply-side friction apply element is complete (i.e., when the determination in step ST4 is YES), the output torque of the motor/generator MG2 is controlled to obtain the original power (step ST5). More specifically, after synchronization is complete, the output torque of the motor/generator MG2, i.e., the input torque Tm of the automatic transmission 3, is increased (from Tm0 to Tm5) (i.e., the absolute value |Tm| of the input torque Tm is reduced) at a predetermined slope so that the output torque To of the automatic transmission 3 comes to match the output torque To5 that is required after the shift as quickly as possible (time t4). After this kind of control ends, this cycle of the routine ends.

Incidentally, in the torque control during a power-off downshift shown in FIG. 7, the determination in step ST2 as to whether the inertia phase has started is made based on the change in a input rotation speed Nm of the automatic transmission 3 after there was a shift demand (i.e., a change in the rotation speed calculated from the output signal from the input shaft rotation speed sensor 203), for example. Also, the synchronization determination in step ST4 is made according to whether the input rotation speed Nm of the automatic transmission 3 has increased to the synchronous rotation speed by the apply-side friction apply element (i.e., the brake B2) after the shift (i.e., 1st), after it has been determined that the inertia phase has started, for example.

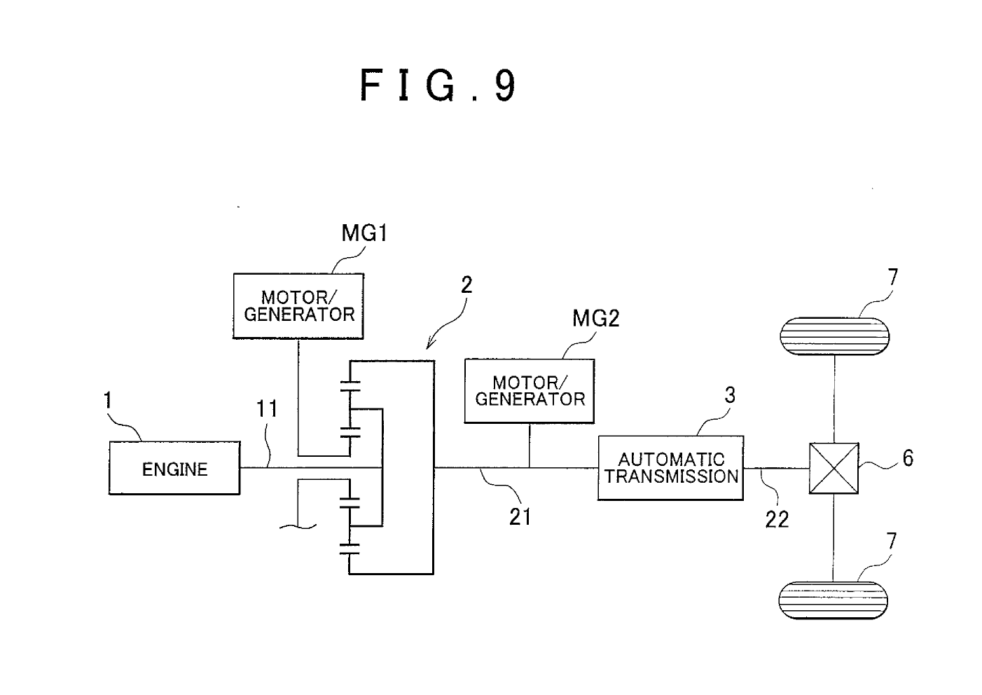

In the foregoing example embodiments the control apparatus of the invention is applied to a hybrid vehicle that has a structure in which the rotating shaft of the motor/generator MG2 is connected to the input shaft 30 of the automatic transmission 3, and the power generated by the motor/generator MG2 is output to the ring gear shaft (i.e., the output shaft) 21 via the automatic transmission 3. However, the invention is not limited to this structure. For example, as shown in FIG. 9, the control apparatus of the invention may also be applied to a hybrid vehicle that has a structure in which the rotating shaft of the motor/generator MG2 is connected to the ring gear shaft 21, and the power generated by the engine 1 and the two motor/generators MG1 and MG2 is transmitted to an output shad 22 (i.e., the driving wheels 7) via the automatic transmission 3.

Also, the control apparatus of the invention is applied to a hybrid vehicle that is provided with two electric motors (i.e., motor/generators or motors). However, the invention is not limited to this structure. That is, the control apparatus of the invention may also be applied to a hybrid vehicle that is provided with one or three or more electric motors (i.e., motor/generators or motors).

In the foregoing example embodiment, a case is described in which a power-off downshift is performed according to clutch-to-clutch shift control. However, the invention is not limited to this. That is, the invention may also be applied to a case in which shift control is performed by an operation that simultaneously releases a one-way clutch which is a release-side apply element and applies an apply-side friction apply element (such as a brake or a clutch) during a downshift.

The foregoing example embodiment describes the invention being applied to a vehicle that is provided with a forward two-speed automatic transmission. However, the invention is not limited to this. That is, the invention may also be applied to a vehicle that is provided with a planetary gear type automatic transmission having any number of speeds.

The foregoing example embodiment describes the invention being applied to a hybrid vehicle that is provided with an engine (i.e., an internal combustion engine) and an electric motor (i.e., a motor/generator) as the driving sources. However, the invention is not limited to this. That is, the invention may also be applied to an electric vehicle (EV) vehicle that only has an electric motor (i.e., motor/generator or motor) as the driving source.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

What is claimed is:

1. A vehicular control apparatus comprising:
an electric motor that outputs driving force for running the vehicle;
an automatic transmission that establishes a plurality of gears by selectively applying and releasing a plurality of friction apply elements in a predetermined combination for each gear among the plurality of gears, and transmits power from the electric motor to an output shaft of the vehicle; and
a torque controlling portion which, when there is a demand for a power-off downshift, controls output torque of the electric motor such that input torque of the automatic transmission becomes constant torque during an inertia phase of that shift, and controls the output torque of the electric motor such that the output torque of the automatic transmission comes to match the torque required after the shift, after rotation synchronization by an apply-side friction apply element is complete.

2. The vehicular control apparatus according to claim 1, wherein the vehicle is a hybrid vehicle that has an internal combustion engine and the electric motor as driving sources.

3. The vehicular control apparatus according to claim 1, further comprising:
an accelerator operation amount sensor that detects an accelerator operation amount of the vehicle; and
a vehicle speed sensor that detects a vehicle speed of the vehicle,
wherein the torque controlling portion determines whether there is a demand for the power-off downshift based on the accelerator operation amount and the vehicle speed.

4. The vehicular control apparatus according to claim 3, wherein the torque controlling portion calculates the torque required after the shift, based on the vehicle speed and the accelerator operation amount.

5. The vehicular control apparatus according to claim 1, wherein the apply-side friction apply element is at least one friction apply element from among the plurality of friction apply elements that is applied when one gear from among the plurality of gears is established.

6. The vehicular control apparatus according to claim 1, wherein the torque controlling portion determines that rotation synchronization by the apply-side friction apply element is complete when an input rotation speed of the automatic transmission has reached a synchronous rotation speed.

7. The vehicular control apparatus according to claim 1, wherein the torque controlling portion increases the output torque of the electric motor at a predetermined slope such that the output torque of the automatic transmission comes to match the torque required after the shift, after rotation synchronization by the apply-side friction apply element is complete.

8. A control method for a vehicle provided with an electric motor that outputs driving force for running the vehicle, and an automatic transmission that establishes a plurality of gears by selectively applying and releasing a plurality of friction apply elements in a predetermined combination for each gear among the plurality of gears, and transmits power from the electric motor to an output shaft of the vehicle, the control method comprising:
controlling, when there is a demand for a power-off downshift, output torque of the electric motor such that input torque of the automatic transmission becomes constant torque during an inertia phase of that shift; and
controlling, after rotation synchronization by an apply-side friction apply element is complete, the output torque of the electric motor such that the output torque of the automatic transmission comes to match the torque required after the shift.

9. The control method according to claim 8, further comprising:
detecting an accelerator operation amount of the vehicle; and
detecting a vehicle speed of the vehicle,
wherein a determination as to whether there is a demand for the power-off downshift is made based on the accelerator operation amount and the vehicle speed.

10. The control method according to claim 9, wherein the torque required after the shift is calculated based on the vehicle speed and the accelerator operation amount.

11. The control method according to claim 8, wherein the apply-side friction apply element is at least one friction apply element from among the plurality of friction apply elements that is applied when one gear from among the plurality of gears is established.

12. The control method according to claim 8, wherein it is determined that rotation synchronization by the apply-side friction apply element is complete when an input rotation speed of the automatic transmission has reached a synchronous rotation speed by the apply-side friction apply element.

13. The control method according to claim 8, wherein the output torque of the electric motor is increased at a predetermined slope such that the output torque of the automatic transmission comes to match the torque required after the shift, after rotation synchronization by the apply-side friction apply element is complete.
